(19) United States
(12) Patent Application Publication
(10) Pub. No.: US 2008/0189301 A1
(43) Pub. Date: Aug. 7, 2008

(54) System and Method of Handling Historical Activities for Membership Changes in Group Collaboration

(76) Inventors: Li Chen, Cary, NC (US); Michael Facemire, Pittsboro, NC (US); Yongcheng Li, Cary, NC (US); Lun Xiao, Cary, NC (US)

Correspondence Address: IBM CORPORATION - RSW (JVL);C/O VAN LEEUWEN & VAN LEEUWEN, P.O. BOX 90609, AUSTIN, TX, 78709-0609, US

(21) Appl. No.: 11/671,137

(22) Filed: Feb. 5, 2007

(51) Int. Cl. G06F 17/30

(52) U.S. Cl. 707/100; 707/E17.005

(57) ABSTRACT

A system and method of handling historical activities for membership changes in group collaboration is presented. A membership manager uses a register service to log group actions that components send to user groups. As such, when the register service receives a member change notification corresponding to a user group, the register service sends action redistribution requests to the components that instruct each of the components to resend the group actions to a new user group member. In one embodiment, the membership manager allows a user to select particular group actions to redistribute to a new member. In this embodiment, the user may also select whether to instruct a component to send event information corresponding to events that have passed, such as a prior month's team meeting notifications, or to only send upcoming event information.

### BACKGROUND OF THE INVENTION

1. Technical Field

The present invention relates to a system and method of handling historical activities for membership changes in group collaboration. More particularly, the present invention relates to a system and method for logging group actions that are sent from components to a user group and, in turn, redistributing the group actions to new user group members.

2. Description of the Related Art

Corporations today are adopting more and more groupware applications and communication tools. For example, most corporations use email applications, instant messaging applications, and calendar applications that allow users to communicate with each other. These applications, or components, typically provide a utility for users to create user groups for sending messages or event invitations to a group of people. For example, a user may create a user group that includes all employees that are involved in a particular project. In this example, the user may use the user group to send emails, instant messages, and calendar events corresponding to the project.

At times, members within a user group may change, such as adding a new employee to a project. This new member may benefit from historical activities, such as previous emails that were sent to the user group. A challenge found, however, is that existing art does not provide an effective solution to resend emails to a new user group member based upon a particular user group.

In addition, recurring activities, such as a weekly team meeting, may have been scheduled prior to a user adding a new member to the user group. As such, the new member's calendar may not include the already scheduled weekly team meetings.

What is needed, therefore, is a system and method for redistributing historical actions across multiple components to a new member of a user group.

### SUMMARY

It has been discovered that the aforementioned challenges are resolved using a system and method for logging group actions that are sent from components to a user group, and redistributing the group actions to subsequent user group members. A membership manager uses a register service to log group actions that components send to user groups. As such, when the register service receives a member change notification corresponding to a user group, the register service sends action redistribution requests to the components that instruct each of the components to resend the group actions to a new user group member.

A membership manager's register service allows different group collaboration components (e.g., email application, calendar application, etc.) to register and provide corresponding group actions that may be later redistributed to new members of a user group. In one embodiment, the group actions may also be redistributed to an existing user group member that changes information, such as changing an email address.

A component, such as a calendar application or an email application, sends a group action to a user group and a membership manager. The membership manager includes a register service, which logs the group action based upon the group action's “group identifier” and “component identifier.” The component identifier identifies the component that sent the group action and the group identifier identifies a user group to which the component sent the group action.

When a user changes member information in the user group, an address book sends a member change notification to the membership manager. For example, the user may add a new member to a user group. The member change notification includes a group identifier that identifies the changed user group, and also includes a member identifier that the user added to the user group. In one embodiment, the user may change an existing user group member's information, or remove a member from the user group.

The membership manager receives the member change notification and retrieves a group action set that corresponds to the group identifier. The group action set includes group actions, sorted by component, that were previously sent to the corresponding user group. The membership manager selects action identifiers corresponding to a particular component and includes them in an action redistribution request, along with a new member identifier, which is sent to the particular component. In turn, the component redistributes the group actions to the new member. Likewise, the membership manager generates action redistribution requests for other components and sends the action redistribution requests to the other components that, as a result, send group actions to the new member.

In one embodiment, the membership manager displays a user interface to the user that allows the user to select particular group actions to redistribute to a new member. In this embodiment, the user may also select whether to instruct a component to send event information corresponding to events that have already occurred, such as a prior month's team meeting notifications, or to only send upcoming event information.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a membership manager using a register service to log group actions received from components and, in turn, sending action redistribution requests to the components in response to receiving a member change notification;

FIG. 2 is a diagram showing a log table that includes group actions sorted by group and component;

FIG. 3 is a flowchart showing steps taken in a membership manager's register service logging group actions it receives from a component;

FIG. 4 is a flowchart showing steps taken in a membership manager's register service receiving a member change notification from an address book and sending action redistribution requests to components to redistribute past group actions to a new member;

FIG. 5 is a user interface window that allows a user to select particular group actions to redistribute to a new member;

FIG. 6A is an example of a group action sent from a component to a membership manager;

FIG. 6B is an example of an action redistribution request that a membership manager sends to a component in response to the membership manager receiving a member change notification; and

FIG. 7 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

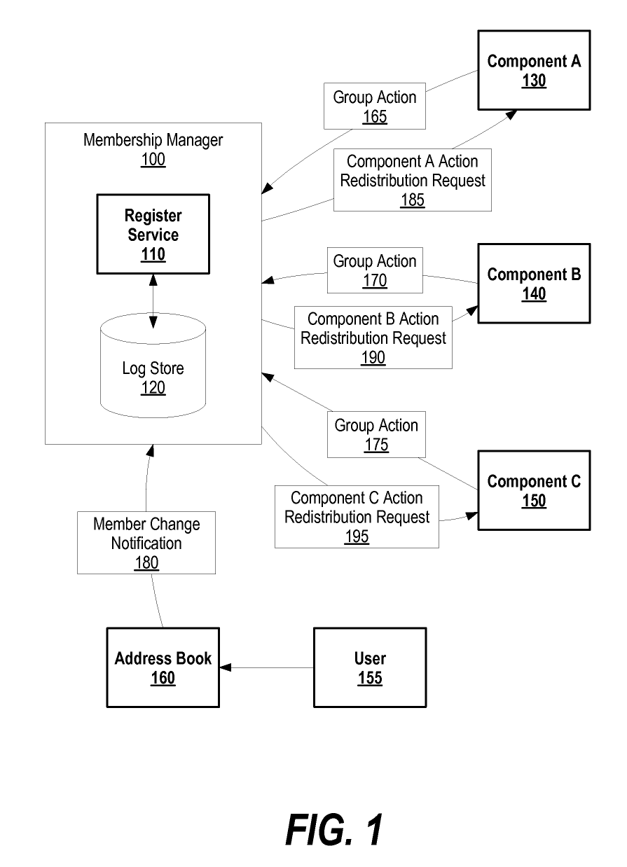

FIG. 1 is a diagram showing a membership manager using a register service to log group actions received from components and, in turn, sending action redistribution requests to the components in response to receiving a member change notification. Membership manager 100 uses register service 110 to receive and log group actions 165, 170, and 175 from component A 130, component B 140, and component C 150, respectively. When membership manager 100 receives a notification that a user (user 155) changed member information within a user group (member changes notification 180), membership manager 100 sends action redistribution requests 185, 190, and 195 to component A 130, component B 140, and component C 150, respectively, to redistribute group actions 165, 170, and 175 to a member identifier included in member change notification 180.

Membership manager 100 includes register service 110, which allows different group collaboration components (e.g., email application, calendar application, etc.) to register themselves and provide corresponding group actions that may be later redistributed to new members of a user group. In one embodiment, the group actions may also be redistributed to an existing user group member that changes information, such as changing an email address.

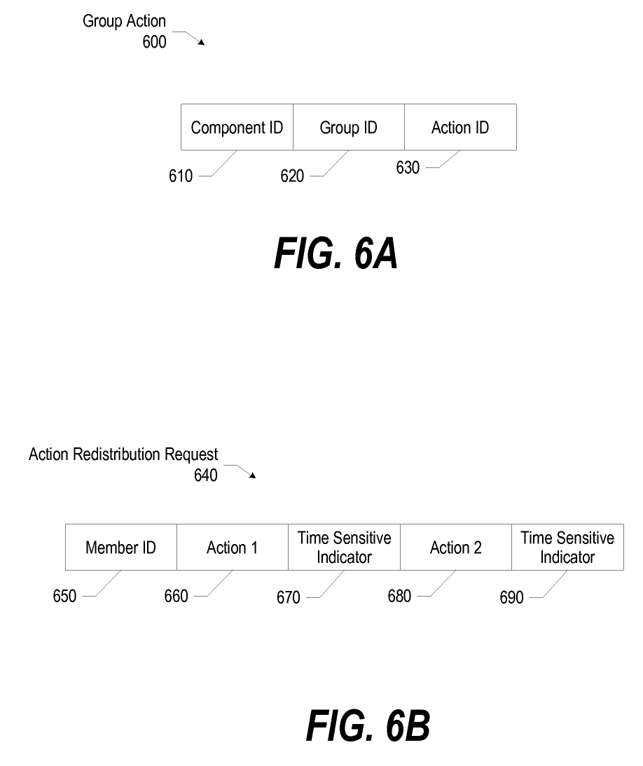

When component A 130 sends a group action to a user group, component A 130 also sends group action 165 to membership manager 110. Group action 165 includes a component identifier, an action identifier, and a group identifier. The component identifier identifies component A 130, the action identifier identifies the particular group action, and the group identifier identifies a user group in which component A 130 sends the group action (see FIG. 6A and corresponding text for further details).

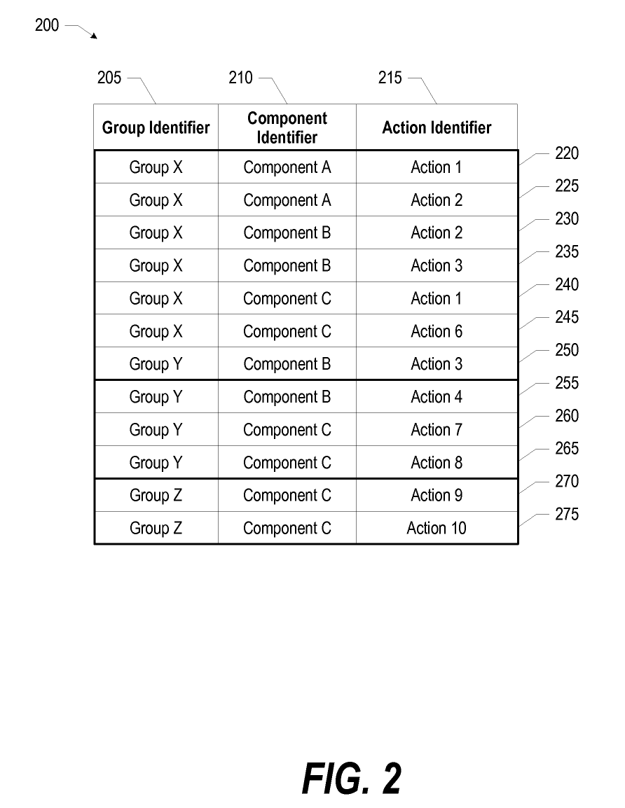

After receiving group action 165, register service 110 logs group action 165 in log store 120 based upon its group identifier and its component identifier (see FIG. 2 and corresponding text for further details). Likewise, when component B 140 and component C 150 send group actions to a user group, component B 140 and component C 150 also send group actions 170 and 175, respectively, to membership manger 100. As such, register service 110 logs group actions 170 and 175 in log store 120 as well.

When user 155 changes a user group in address book 160, address book 160 sends member change notification 180 to membership manager 100. For example, user 155 may add a new member to a user group. Member change notification 180 includes a group identifier that identifies the changed user group, and also includes a member identifier that user 155 added. In one embodiment, user 155 may remove a member from the user group. In this embodiment, membership manager 100 may send clean up actions such as sending a meeting cancellation notice to the removed member for already scheduled meetings.

Membership manager 100 receives member change notification 180 and retrieves a group action set that corresponds to the group identifier. The group action set includes group actions, sorted by component, that were previously sent to the group identifier's corresponding user group (see FIG. 2 and corresponding text for further details). Membership manager 100 selects group action identifiers corresponding to component A 130 and includes them in component A action redistribution request 185, which is sent to component A 130. In turn, component A 130 redistributes the group actions to the member identifier included in component A action redistribution request 185, such as that corresponding to group action 165.

Likewise, membership manager 100 selects group action identifiers corresponding to component B 140 and component C 150, and includes them in component B action redistribution request 190 and component C action redistribution request 195, respectively. In turn, component B 140 and component C 150 redistribute group actions to the member identifier.

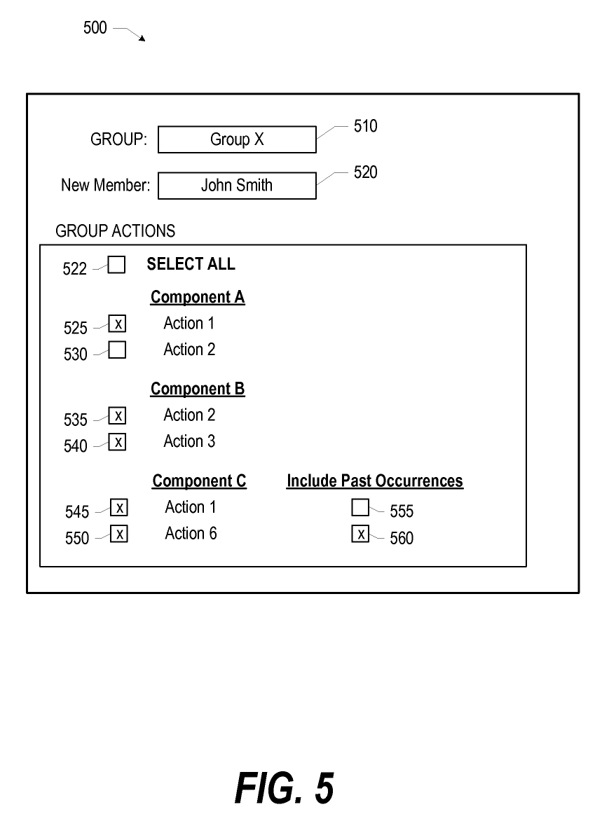

In one embodiment, membership manager 100 displays a user interface to user 155 that allows user 155 to select particular group actions to redistribute to a member. In this embodiment, user 155 also may select whether to instruct a component to send event information corresponding to events that have passed, such as a prior month's team meeting notifications, or to only send upcoming event information (see FIG. 5 and corresponding text for further details).

FIG. 2 is a diagram showing a log table that includes group actions sorted by group and component. A membership manager receives group actions from components that the components send to user groups. In turn, the membership manager's register service logs the group actions by group identifier and component identifier in table 200 such that when the membership manager receives a member change notification, the membership manager is able to include action identifiers corresponding to a particular user group in an action redistribution request that corresponds to a particular component.

Table 200 includes columns 205, 210, and 215. Column 205 includes a list of group identifiers whose corresponding user groups were sent group actions by a particular component. Column 210 includes a list of component identifiers, which identify components that sent group actions to the group identifiers shown in column 205. Column 215 includes a list of action identifiers, which correspond to group actions that were sent from a particular component to a particular user group. For example, rows 220 and 225 include action identifiers that were sent from component A to user group X.

Table 200 shows that entries are sorted into component action sets and group action sets. A “component action set” includes actions that are sent from a particular component to a particular user group. Rows 220 and 225 are one component action set, rows 230 and 235 are another component action set, and rows 240 and 245 are yet another component action set. A “group action set” includes component action sets that are sent to a particular user group. Meaning, rows 220-245 comprise a group action set for user group X, rows 250-265 comprise a group action set for user group Y, and rows 270-275 comprise a group action set for user group Z.

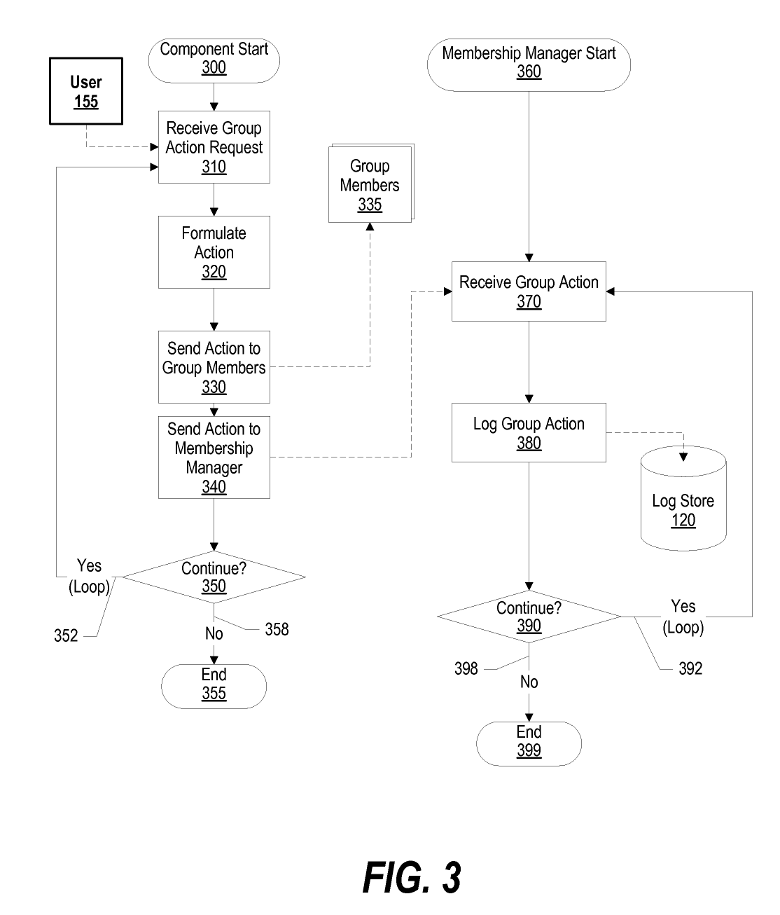

FIG. 3 is a flowchart showing steps taken in a membership manager's register service logging group actions it receives from a component. For example, the component may be an email messaging system that user 155 uses to send group emails to group members 335, such as a group of users belonging to a particular project. User 155 is the same as that shown in FIG. 1.

Component processing commences at 300, whereupon processing receives a group action request from user 155 at step 310. Again, the group action request may be a request to send a group email, or the action request may be a request to send a recurring calendar event, such as a weekly meeting reminder, to each of group members 335.

At step 320, processing formulates the group action and, at step 330, processing sends the group action to each of group members 335. Next, processing sends the group action to the membership manager, such as membership manager 100 shown in FIG. 1 (step 340). In one embodiment, processing sends the group action to group members 335 and the membership manager in the same step.

A determination is made as to whether component processing should continue (decision 350). If component processing should continue, decision 350 branches to “Yes” branch 352 whereupon processing loops back to continue to process group action requests from user 155. This looping continues until component processing should terminate, at which point decision 350 branches to “No” branch 358 whereupon component processing ends at 355.

Membership manager processing commences at 360, whereupon it receives a group action from the component at step 370. The group action includes a component identifier and a group identifier, which corresponds to group members 335. This allows the membership manager's register service to log the group action in log store 120 (step 380) based upon group identifiers and component identifiers (see FIG. 2 and corresponding text for further details). Log store 120 is the same as that shown in FIG. 1.

A determination is made as to whether to continue membership manager processing (decision 390). If processing should continue, decision 390 branches to “Yes” branch 392, which loops back to continue to receive and log group actions. This looping continues until membership manager processing should terminate, at which point decision 390 branches to “No” branch 398 whereupon processing ends at 399.

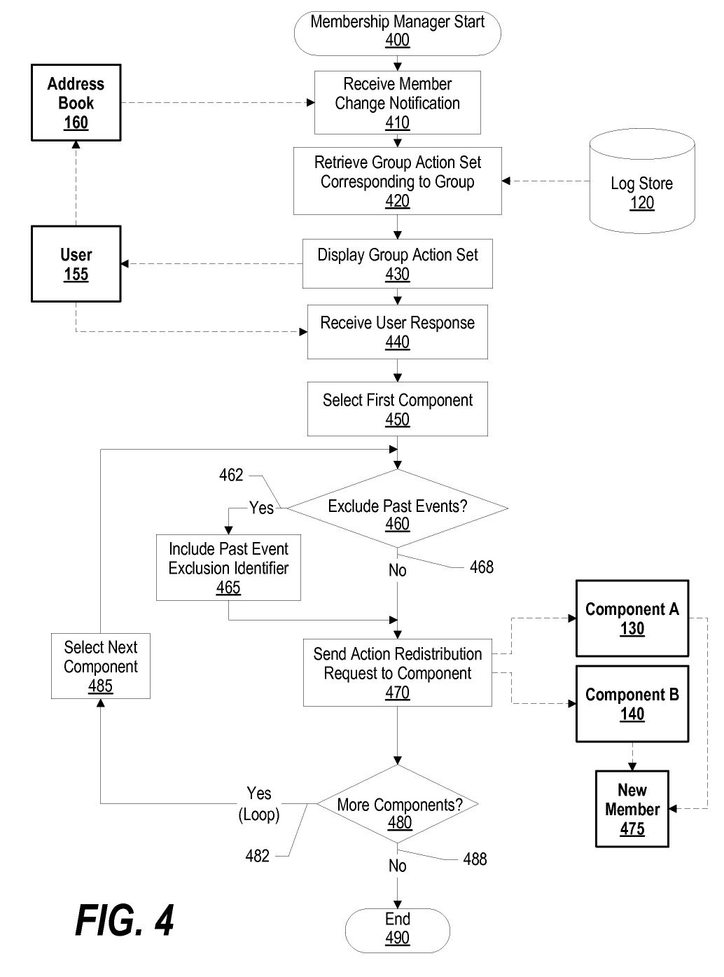

FIG. 4 is a flowchart showing steps taken in a membership manager's register service receiving a member change notification from an address book and sending action redistribution requests to components to redistribute past group actions to a new member. The membership manager's register service has been storing group actions it receives from components based upon group identifiers and component identifiers (see FIG. 3 and corresponding text for further details).

Membership manager processing commences at 400, whereupon processing receives a member change notification from address book 160 at step 410. The member change notification is in response to user 155 changing a user group's member information that is stored in address book 160. For example, user 155 may have added a new member to a user group, removed a member from a user group, or changed an existing member's information in a user group. User 155 and address book 160 are the same as that shown in FIG. 1.

At step 420, processing retrieves a group action set from log store 120 that corresponds to a group identifier included in the member change notification. The group action set includes group actions, sorted by component, that were previously sent to a user group corresponding to the group identifier. Log store 120 is the same as that shown in FIG. 1.

Processing, at step 430, displays the group action set to user 155 in order for user 155 to select which group actions to redistribute to a new member identifier included in the member change notification. When a group action includes time sensitive information, such as calendar events, user 155 may choose whether to send past event information to a new member, or just send future events to the member (see FIG. 5 and corresponding text for further details). In one embodiment, the membership manager's register service may automatically send action redistribution requests to particular components without user 155 interaction.

User 155 selects which group actions to redistribute to the member, and provides a user selection to the membership manager (step 440). Processing selects a first component at step 450, and a determination is made as to whether the user selection included a past event exclusion selection for one or more of the group actions corresponding to the selected component (decision 460). For example, user 155 may not wish a new member to receive meeting notifications for meetings that have already occurred.

If the user selection included a past event exclusion selection for one or more of the group actions corresponding to the selected component, decision 460 branches to “Yes” branch 462 whereupon processing includes a past event exclusion indicator in an action redistribution request for each selected time sensitive group action. On the other hand, if the user selection did not include a past event exclusion selection for any of the group actions corresponding to the selected group, decision 460 branches to “No” branch 468 bypassing past event exclusion steps.

Processing, at step 470, sends an action redistribution request to the selected component, such as component A 130 or component B 140. The action redistribution request includes a member identifier, group action identifiers for each group action, and may include one or more past event exclusion indicators for one or more of the group actions (see FIG. 6B and corresponding text for further details). In turn, the component, such as component A 130 or component B 140, sends previously sent group actions to a member identifier included in the action redistribution request (new member 475). Component A 130 and component B 140 are the same as that shown in FIG. 1.

A determination is made as to whether there are more components to send action redistribution requests (decision 480). If there are more components to send action redistribution requests, decision 480 branches to “Yes” branch 482, which loops back to select the next component (step 485) and send an action redistribution request to the next component. This looping continues until there are no more components to send an action redistribution request, at which point decision 480 branches to “No” branch 488 whereupon membership manager processing ends at 490.

FIG. 5 is a user interface window that allows a user to select particular group actions to redistribute to a new member. When a membership manager receives a member change notification corresponding to a user group, the membership manager retrieves group action identifiers corresponding to a changed user group and displays them in window 500. In turn, a user is able to select particular group actions to redistribute to a new member of the user group.

Window 500 includes text boxes 510 and 520. Text box 510 includes a user group identifier and text box 520 includes a new member identifier, both of which correspond to the member change notification. Window 500 also includes boxes 522 through 550 that allow a user to select particular group actions to redistribute to the new member identifier displayed in box 520. When a user wishes to send all group actions from each component to the new member identifier, the user selects box 522. The example shown in FIG. 5 shows that the user selected boxes 525, 535, 540, 545, and 550 to send corresponding group actions to the new member identifier.

Window 500 also includes boxes 555 and 560, which correspond to time sensitive group actions. For example, component C may be a calendar system and actions 1 and 6 may be weekly meeting notifications. In this example, when the user wishes component C to send only future notifications to the new member identifier, the user selects boxes 555 or 560. When the user wishes component C to send all meeting notifications (including those that have already occurred), the user leaves boxes 555 and 560 unchecked (see FIG. 4 and corresponding text for further details).

FIG. 6A is an example of a group action sent from a component to a membership manager. Group action 600 includes fields 610 through 630. Field 610 includes a component identifier that corresponds to the component sending group action 600. Field 620 includes a group identifier that corresponds to the user group to which the component sends the group action. And, field 630 includes an action identifier that identifies the particular group action.

FIG. 6B is an example of an action redistribution request that a membership manager sends to a component in response to the membership manager receiving a member change notification. Action redistribution request 640 instructs a component to redistribute previously sent group actions to a new member of a user group.

Action redistribute request 640 includes fields 650 through 690. Field 650 includes a new member identifier for which to send particular group actions. In one embodiment, the new member identifier may correspond to an existing user group member that may have changed information, such as a new email address. Field 660 and 680 include action identifiers that identify particular group actions to send to the new member identifier. And, fields 670 and 690 include past event exclusion identifiers corresponding to fields 660 and 680, respectively. The past event exclusion identifiers instruct the component whether to send information regarding events that have already occurred to the new member identifier, such as previous meeting notifications. When a group action identifier does not correspond to time sensitive actions, action redistribution request 640 may not include a corresponding field for a past event exclusion identifier.

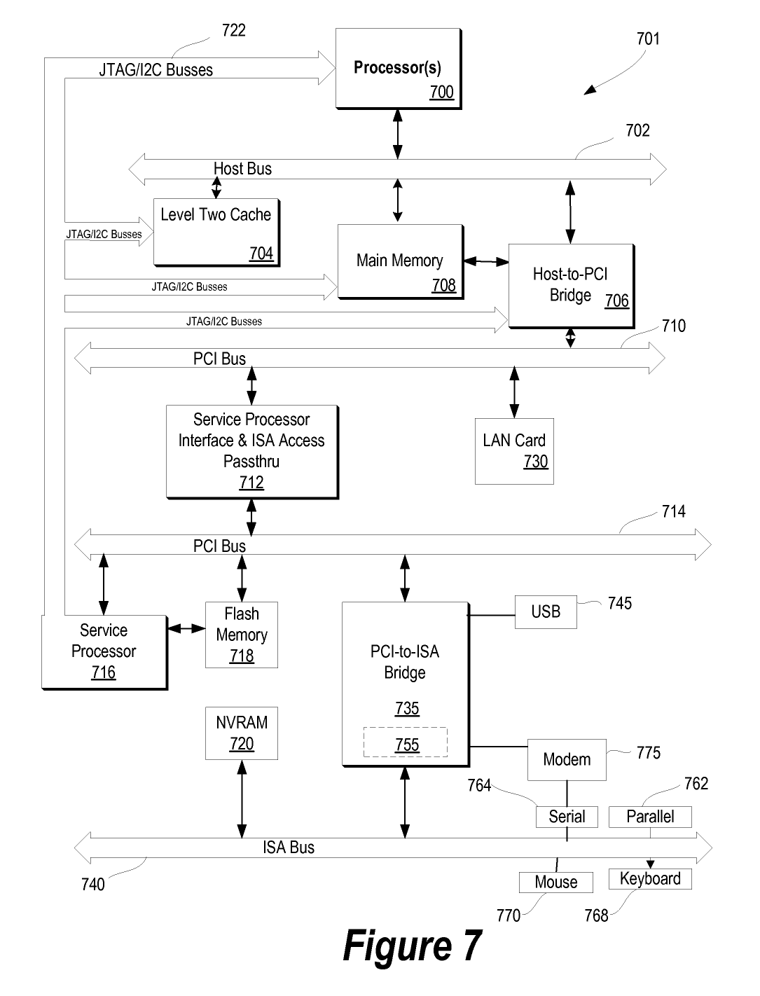

FIG. 7 illustrates information handling system 701 which is a simplified example of a computer system capable of performing the computing operations described herein. Computer system 701 includes processor 700 which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While FIG. 7 shows one information handling system that employs processor(s) 700, the information handling system may take many forms. For example, information handling system 701 may take the form of a desktop, server, portable, laptop, notebook, or other form factor computer or data processing system. Information handling system 701 may also take other form factors such as a personal digital assistant (PDA), a gaming device, ATM machine, a portable telephone device, a communication device or other devices that include a processor and memory.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “aa” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
receiving a group action from a component at a membership manager, the component also sending the group action to a plurality of user identifiers included in a user group;
storing the group action at the membership manager;
receiving a member change notification at the membership manager that includes a group identifier and a new member identifier, the new member identifier not included in the user group;
determining that the group identifier corresponds to the user group; and
in response to determining that the group identifier corresponds to the user group, sending an action redistribution request to the component that instructs the component to send the group action to the new member identifier.

2. The method of claim 1 further comprising:
receiving, at the component, the action redistribution request; and
sending, from the component, the group action to the new member identifier in response to receiving the action redistribution request.

3. The method of claim 1 further comprising:
receiving a plurality of group actions from each of a plurality of components, the group action included in the plurality of actions and the component included in plurality of components; and
storing each of the plurality of group actions in one of a plurality of component action sets, each of the plurality of component action sets corresponding to one of the plurality of components.

4. The method of claim 3 further comprising:
displaying a user interface that includes each of the plurality of group actions sorted by each of the plurality of component action sets;
receiving a user selection that identifies one or more of the plurality of group actions to send to the new member identifier; and
sending one or more of the action redistribution requests to one or more of the plurality of components based upon the user selection.

5. The method of claim 4 wherein the user selection includes a past event exclusion selection, the method further comprising:
including a past event exclusion indicator in one of the action redistribution requests, the past event exclusion identifier instructing the component to exclude events that have already occurred;
identifying, at the component, future events that correspond to the group action based upon the past event exclusion indicator; and
sending only the future events in the group action to the new member identifier.

6. The method of claim 1 wherein the component is selected from the group consisting of an email component, a calendar component, and an instant messaging component.

7. The method of claim 1 wherein the member change notification is sent from an address book that includes the user group, the user group accessed by a plurality of components that are different from each other.

8. A computer program product stored on a computer operable media, the computer operable media containing instructions for execution by a computer, which, when executed by the computer, cause the computer to implement a method to redistribute group actions to a new user group member, the method comprising:
receiving a group action from a component at a membership manager, the component also sending the group action to a plurality of user identifiers included in a user group;
storing the group action at the membership manager;
receiving a member change notification at the membership manager that includes a group identifier and a new member identifier, the new member identifier corresponding to the new user group member and not included in the user group;
determining that the group identifier corresponds to the user group; and
in response to determining that the group identifier corresponds to the user group, sending an action redistribution request to the component that instructs the component to send the group action to the new member identifier.

9. The computer program product of claim 8 wherein the method further comprises:
receiving, at the component, the action redistribution request; and
sending, from the component, the group action to the new member identifier in response to receiving the action redistribution request.

10. The computer program product of claim 8 wherein the method further comprises:
receiving a plurality of group actions from each of a plurality of components, the group action included in the plurality of actions and the component included in plurality of components; and
storing each of the plurality of group actions in one of a plurality of component action sets, each of the plurality of component action sets corresponding to one of the plurality of components.

11. The computer program product of claim 10 wherein the method further comprises:
displaying a user interface that includes each of the plurality of group actions sorted by each of the plurality of component action sets;
receiving a user selection that identifies one or more of the plurality of group actions to send to the new member identifier; and
sending one or more of the action redistribution requests to one or more of the plurality of components based upon the user selection.

12. The computer program product of claim 11 wherein the user selection includes a past event exclusion selection, the method further comprising:
including a past event exclusion indicator in one of the action redistribution requests, the past event exclusion identifier instructing the component to exclude events that have already occurred;
identifying, at the component, future events that correspond to the group action based upon the past event exclusion indicator; and
sending only the future events in the group action to the new member identifier.

13. The computer program product of claim 8 wherein the component is selected from the group consisting of an email component, a calendar component, and an instant messaging component.

14. The computer program product of claim 8 wherein the member change notification is sent from an address book that includes the user group, the user group accessed by a plurality of components that are different from each other.

15. An information handling system comprising: one or more processors;
a memory accessible by the processors;
one or more nonvolatile storage devices accessible by the processors; and
a set of instructions stored in the memory, wherein one or more of the processors executes the set of instructions in order to perform actions of:
receiving a group action from a component at a membership manager, the component also sending the group action to a plurality of user identifiers included in a user group;
storing the group action in one of the nonvolatile storage devices at the membership manager;
receiving a member change notification at the membership manager that includes a group identifier and a new member identifier, the new member identifier corresponding to the new user group member and not included in the user group;
determining that the group identifier corresponds to the user group; and
in response to determining that the group identifier corresponds to the user group, sending an action redistribution request to the component that instructs the component to send the group action to the new member identifier.

16. The information handling system of claim 15 further comprising an additional set of instructions in order to perform actions of:
receiving, at the component, the action redistribution request; and
sending, from the component, the group action to the new member identifier in response to receiving the action redistribution request.

17. The information handling system of claim 15 further comprising an additional set of instructions in order to perform actions of:
receiving a plurality of group actions from each of a plurality of components, the group action included in the plurality of actions and the component included in plurality of components; and
storing each of the plurality of group actions in one of a plurality of component action sets located in one of the nonvolatile storage devices, each of the plurality of component action sets corresponding to one of the plurality of components.

18. The information handling system of claim 17 further comprising an additional set of instructions in order to perform actions of:
displaying a user interface on a display that includes each of the plurality of group actions sorted by each of the plurality of component action sets;
receiving a user selection that identifies one or more of the plurality of group actions to send to the new member identifier; and
sending one or more of the action redistribution requests to one or more of the plurality of components based upon the user selection.

19. The information handling system of claim 18 wherein the user selection includes a past event exclusion selection, the information handling system further comprising an additional set of instructions in order to perform actions of:
including a past event exclusion indicator in one of the action redistribution requests, the past event exclusion identifier instructing the component to exclude events that have already occurred;
identifying, at the component, future events that correspond to the group action based upon the past event exclusion indicator; and
sending only the future events in the group action to the new member identifier.

20. The information handling system of claim 15 wherein the component is selected from the group consisting of an email component, a calendar component, and an instant messaging component.
